(19) United States
(12) Patent Application Publication
(10) Pub. No.: US 2025/0250106 A1
(43) Pub. Date: Aug. 7, 2025

(54) BAG ADAPTER FOR WASTE DISPOSAL DEVICE

(71) Applicant: ANGELCARE CANADA INC., Montréal (CA)

(72) Inventors: Michel MORAND, Montreal (CA); Hugo MOERMAN ROUSSEAU, St-Hubert (CA)

(21) Appl. No.: 18/856,720

(22) PCT Filed: Apr. 14, 2023
(86) PCT No.: PCT/CA2023/050509

§ 371 Date: Oct. 14, 2024

Related U.S. Application Data
(60) Provisional application No. 63/330,867, filed on Apr. 14, 2022.

(51) Int. Cl. B65F 1/06; B65F 1/16

(52) U.S. Cl. CPC B65F 1/062; B65F 1/1646; B65F 2001/1676; B65F 2240/132

(57) ABSTRACT

A bag adapter for hanging a bag to a top container rim of a container circumscribing a container opening at least equal in dimension to the bottom bag dimension, a bag having a bottom bag dimension at most equal to a throat section of the container, the container opening being at least equal in dimension to the bottom bag dimension. The bag adapter may have a seating frame having an inner seating frame periphery circumscribing a seating frame opening, the seating frame sized to be mounted onto the top container rim such that the seating frame opening is in communication with the container opening. A kit is provided and may include the bag adapter, one or more bags. The bags may be in a roll.

### CROSS-REFERENCE TO RELATED APPLICATION

The present application claims the priority of U.S. Patent Application No. 63/330,867, filed on Apr. 14, 2022, the contents of which are incorporated herein by reference.

### FIELD OF THE APPLICATION

The present application relates to a bag adapter of the type used with a waste disposal device and, more particularly but not exclusively, to a bag adapter used to support bags for the disposal of odorous waste, such as diapers and litter, in waste disposal devices having odor-concealing systems.

### BACKGROUND OF THE ART

Waste disposal devices having bag-dispensing, bag-holding and/or odor-concealing systems are well known. Such waste disposal devices typically cooperate with a suitably sized bag to support it such that the bag is selectively closable by a lid and/or other given mechanisms of the device, thereby concealing waste and related odors within the bag. U.S. patent application Ser. No. 16/603,113 (Morand et al.) and U.S. Pat. No. 9,938,045 (Morand) propose such waste disposal devices. Nevertheless, it may be appropriate to reconsider the ways in which known waste disposal devices interface with bags.

### SUMMARY OF THE APPLICATION

It is therefore an aim of the present disclosure to provide a novel bag adapter for a waste disposal device.

Therefore, in accordance with an aspect of the present disclosure, there is a bag adapter for hanging a bag to a top container rim of a container circumscribing a container opening at least equal in dimension to the bottom bag dimension, a bag having a bottom bag dimension at most equal to a throat section of the container, the container opening being at least equal in dimension to the bottom bag dimension, the bag adapter comprising a seating frame having an inner seating frame periphery circumscribing a seating frame opening, the seating frame sized to be mounted onto the top container rim such that the seating frame opening is in communication with the container opening.

Further in accordance with the first aspect, optionally, the seating frame has an annular body.

Still further in accordance with the first aspect, optionally, the annular body tapers from a top peripheral edge to a bottom peripheral edge.

Still further in accordance with the first aspect, optionally, the annular body defines an outer seating frame periphery that corresponds in shape and/or in dimension to seating frame opening.

Still further in accordance with the first aspect, optionally, the outer seating frame periphery is between the top peripheral edge and the bottom peripheral edge such that the annular body is seated in the seating frame opening.

Still further in accordance with the first aspect, optionally, the annular body has a bottom peripheral edge having a dimension greater than that of the container opening, such that the annular body is configured to be seated to a surface of the container surrounding the container opening.

Still further in accordance with the first aspect, optionally, a flange projects from and surrounds the annular body, the flange configured to be supported against a surface of the container when the bag adapter is mounted to the container.

Still further in accordance with the first aspect, optionally, the seating frame is laterally open.

Still further in accordance with the first aspect, optionally, a clamping frame may be pivotally connected to the seating frame, the clamping frame closing onto the seating frame to hold a bag therebetween.

Still further in accordance with the first aspect, optionally, the seating frame has a bottom peripheral edge having a dimension greater than that of the container opening, such that the seating frame is configured to be seated to a surface of the container surrounding the container opening.

Still further in accordance with the first aspect, optionally, a flange projects from and surrounds the seating frame, the flange configured to be supported against a surface of the container when the bag adapter is mounted to the container.

Still further in accordance with the first aspect, optionally, the seating frame has at least one tab projecting from the flange, the at least one tab projecting toward the container upon the bag adapter being mounted to the container.

Still further in accordance with the first aspect, optionally, a tab projects from the clamping frame, the tab for pivoting the clamping frame relative to the seating frame.

In accordance with a second aspect of the present disclosure, there is provided a kit comprising: the bag adapter as described above; and at least one bag, the bag having a bottom bag dimension at most equal to a throat section of the container.

Further in accordance with the second aspect, optionally, the bottom bag dimension has a dimension smaller than the seating frame opening.

Still further in accordance with the second aspect, optionally, the bottom bag dimension is smaller than a top bag periphery.

Still further in accordance with the second aspect, optionally, a plurality of the bag may be provided.

Still further in accordance with the second aspect, optionally, the bags of the plurality are in a roll.

Still further in accordance with the second aspect, optionally, the bags in the roll are connected from a bottom of one of the bags to a top of a subsequent one of the bags.

Still further in accordance with the second aspect, optionally, the roll is in a cassette body.

### BRIEF DESCRIPTION OF THE DRAWINGS

FIG. 1 is a perspective view of a bag adapter in accordance with an embodiment of the present disclosure, seated on a waste disposal device with a lid assembly open;

FIG. 2 is a perspective view of the bag adapter of FIG. 1;

FIG. 3 is an exploded perspective view of the bag adapter of FIG. 1 supporting a bag above the waste disposal device, the lid assembly having been removed;

FIG. 4 is a cross-sectional view of the bag adapter, the bag and the waste disposal device taken along the line 4-4 of FIG. 3;

FIG. 5 is a perspective view of the bag adapter of FIG. 1 seated onto the waste disposal device with the bag;

FIG. 6 is a cross-sectional view of the bag adapter, the bag and the waste disposal device taken along the line 6-6 of FIG. 5;

FIG. 7 is a perspective view of a bag adapter in accordance with another embodiment of the present disclosure, seated on the waste disposal device of FIG. 1 with the lid assembly open;

FIG. 8 is a perspective view of the bag adapter of FIG. 7, with the bag adapter being in a closed position;

FIG. 9 is a perspective view of the bag adapter of FIG. 7, with the bag adapter being in an open position;

FIG. 10 is a perspective view of the bag adapter of FIG. 7 seated onto the waste disposal device with a bag, the bag adapter being in the open position and the lid assembly having been removed;

FIG. 11 is a cross-sectional view of the bag adapter, the bag and the waste disposal device taken along the line 11-11 of FIG. 10;

FIG. 12 is a perspective view of the bag adapter of FIG. 7 seated onto the waste disposal device with the bag, the bag adapter being in the closed position and the lid assembly having been removed;

FIG. 13 is a cross-sectional view of the bag adapter, the bag and the waste disposal device taken along the line 13-13 of FIG. 12; and

FIG. 14 is a cross-sectional view of a bag adapter in accordance with another embodiment of the present disclosure, seated on a waste disposal device.

### DESCRIPTION OF THE PREFERRED EMBODIMENTS

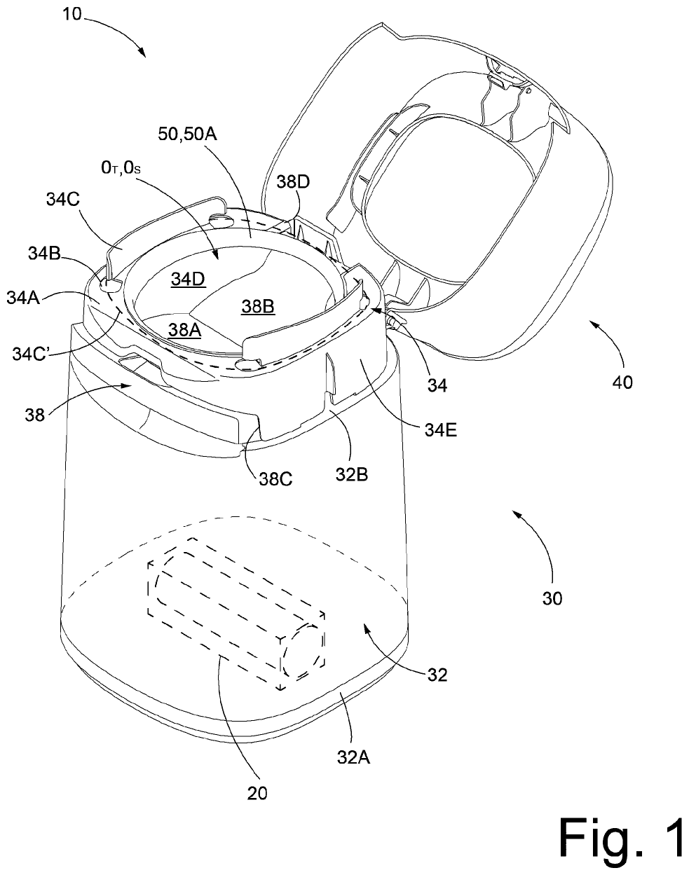

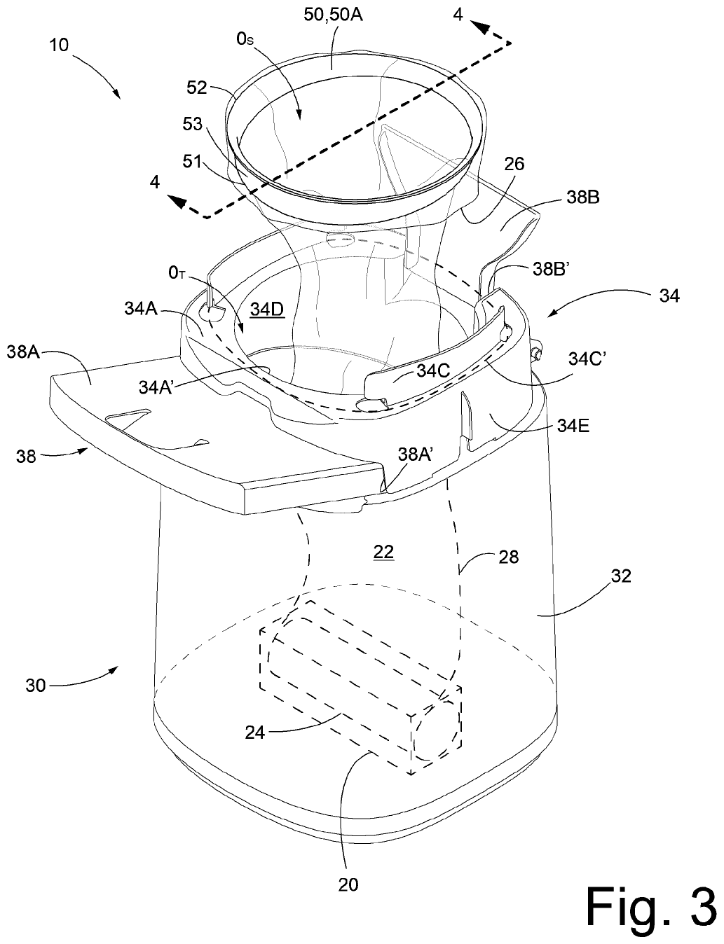

Referring to the drawings and more particularly to FIG. 1, a waste disposal device (hereinafter “device”) is generally shown at 10. The device 10 may be known as a pail, a bin, a can, etc. The device 10 may be used for any suitable type of waste, including diapers, soiled litter, refuse, etc. In an embodiment, the device 10 is used to receive odorous waste, and has an odor concealing system to retain odors within the device 10, by closing a bag that encloses the odorous waste. As shown in FIG. 3, the device 10 is of the type using a film dispensing cassette 20 (hereinafter “cassette” 20) dispensing film that may be a series of pre-formed bags 22 connected end to end. The device 10 may also be used with individual bags 22. The film may otherwise be a tubular wall intended to be cut to desired lengths and tied at one end so as to form the bags 22. Other suitable types of bag dispensers may be used with the device 10 as well. Moreover, the expression cassette is one among others to describe item 20, with other expressions including cartridge, refill, etc. The cassette 20 may be part of the device 10, or may also be an accessory used with the device 10, with the device 10 sold with or without the cassette 20. It is also contemplated that the cassette 20 may be omitted. Here, the bag 22 is shown as being dispensed from the cassette 20, although the bag 22 could be sourced otherwise. The bag 22 has a closed bag bottom 24, a bag brim 26 (i.e., an open top), and a peripheral bag wall 28 extending therebetween, the bag wall 28 being tubular. The bag bottom 24 and the bag brim 26 respectively have a bottom bag dimension 24′ (or width 24′) and a top bag dimension 26′. One could refer to dimensions 24′ and/or 26′ as circumferences, as the bag 22 may adopt a generally rounded or elliptical shape once hung to the device 10 and/or once filled with waste. However, the bags 22 described herein may be available in a flat condition, in which case the bags 22 may be referred to as having a flattened two-fold condition with the two halves of the bags 22 being coplanar, such as found in rolls at grocery stores. The folds may simply be the result of the tubular film being flattened, or could also be made by weld seams, such as ones defining tapers from top of the bag 22 to the bottom of the bag 22.

If used herein to describe the bag 22, the term “circumference” may be construed as meaning a closed, two-dimensional path defined by one or more surfaces, whether continuously (as the case may be if the surface(s) define a closed contour) or discontinuously (as the case may be if the surface(s) define an open contour, in which case the circumference interpolates the contour across discontinuities). The bottom bag dimension 24′ is a closed contour, or closed end. In a variant, the bag 22 is tubular film, and the bottom of the bag 22, defining the bottom bag dimension 24′, is one or more weld seams. The bag 22 could also be manually knotted at its bottom end. The top bag periphery 26′ may in some cases be an open contour, for example when the bag 22 defines handles, prongs or other like features at its bag brim 26. Here, the top bag periphery 26′ is greater than the bottom bag dimension 24′, and the peripheral bag wall 28 may taper from the bag brim 26 to the bag bottom 24. It is contemplated however that other configurations are possible for the bag 22, including but not limited to straight configurations in which the top bag periphery 26′ corresponds to the bottom bag dimension 24′. If the bag brim 26 is larger than the bag bottom 24, arrangements other than a taper may be present, such as a step or steps, linear or non-linear tapers, etc.

The device 10 generally includes a container 30 forming a structural component of the device 10 that is sized to accommodate and conceal the bag 22 together with its contents in an interior of the container 30. A lid assembly 40 is optionally present and may be movably connected to the container 30 so as to selectively allow access to the interior of the container 30 and hence to the bag 22. As will be described hereinbelow, whereas the container 30 defines bag retention feature(s) via which the bags 22 are securable directly to the container 30 provided that the bags 22 have certain retention-compatible (i.e., consistent with the bag retention feature(s)) size(s) and/or feature(s) at their brim 26, a bag adapter 50 may be provided as an alternate securing means to secure certain bags 22 indirectly to the container 30, in some cases despite some such bags 22 not having the retention-compatible size(s) and/or feature(s). Stated differently, the bags 22 may not have a suitable size and/or feature to be mounted directly to the container 30, the bags 22 relying on the bag adapter 50 to be installed in the container 30.

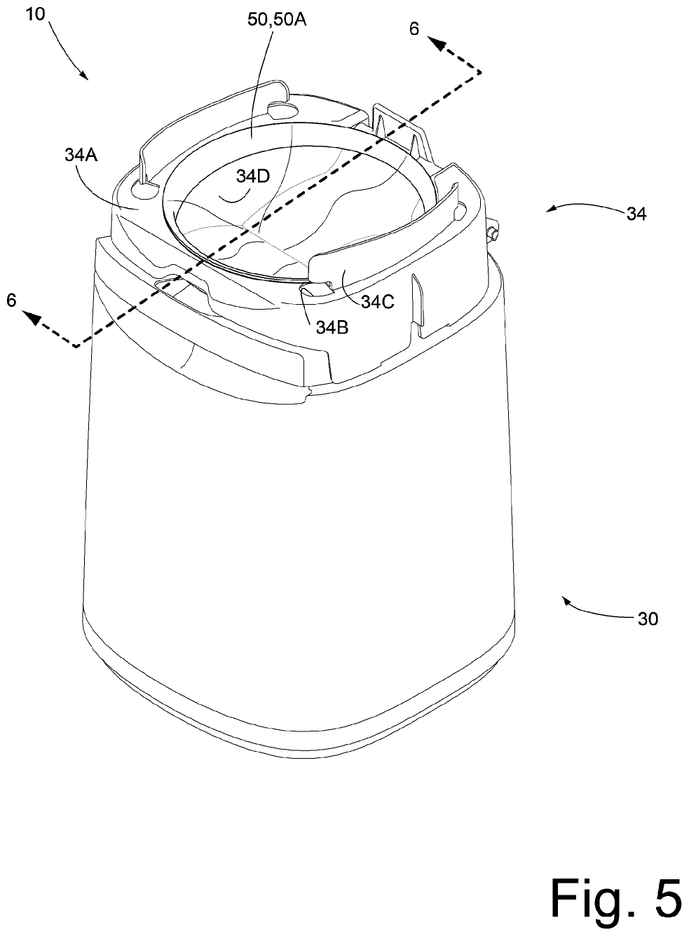

Referring to FIGS. 1 and 3-6, the container 30 will now be described in greater detail. It should be noted that shape(s) of the container 30 illustrated in the Figs are merely exemplary, and that other shapes may be suitable provided that they are consistent with the forthcoming description. Moreover, one given type of closing mechanism is shown, but other closing mechanism types may be used. The container 30 includes a hollow body 32 extending from a bottom end 32A to a top end 32B. The body 32 has a squircle-like cross-sectional shape and may taper as it extends heightwise from the bottom end 32A to the top end 32B. Any suitable cross-sectional shape may be used, such as round, square, oval, polygonal, to name a few examples, and a taper is optional. Moreover, any suitable geometry is considered for the body 32 as well, including but not limited to prismatic, cylindrical and/or frustoconical shapes. At the bottom end 32A, the body 32 defines a base portion that rests on the ground or floor, with or without legs. The cassette 20, if present, is located in an interior of the container 30 proximate to the base portion and may be affixed to the base portion. The base portion may or may not be separable from a remainder of the body 32 to provide access to the interior of the container 30. It is also contemplated that the base portion may be omitted, i.e., the container 30 may be open at the bottom end 32A. At the top end 32B, the body 32 is partially closed by a top container rim 34 (hereinafter “container rim” 34) of the container 30. A top container opening O_{T} of the container 30, defined by the container rim 34, provides access to the interior of the container 30 at the top end 32B. The container rim 34 includes a shoulder 34A surrounding the top container opening O_{T}. The top container opening O_{T} of the container 30 may be defined as being a throat as it may be the narrowest portion of the device 10, through which the bag 22 filled with waste must be pulled out. The shoulder 34A defines an inner container shoulder periphery 34A′ (hereinafter “inner shoulder periphery” 34A′ or “first container opening periphery” 34A′) that circumscribes the top container opening O_{T}, in this case at an uppermost end thereof. If the top container opening O_{T} is circular or elliptical, etc, the periphery could be a circumference. However, for simplicity, the expression “periphery” is used. The shoulder 34A may also include one or more bag retention features disposed peripherally relative to the inner shoulder circumference 34A′. Such bag retention features may include indentations such as holes 34B, or projections such as collars 34C. At least some of the bag retention features 34B, 34C may define a bag deployment circumference or periphery 34C′. The container 30 may thus be said to be configured for use with bags 22 whose top bag periphery 26′ is at least equal to the bag deployment circumference or periphery 34C′. The bag retention features may be hooks, tongues, fingers, a hoop, etc.

Proximate to the top end 32B, the container 30 has a container peripheral wall surrounding the top container opening O_{T}. In this implementation, the container peripheral wall forms part of the container rim 34, and the shoulder 34A may be said to sit atop the peripheral wall. An inner peripheral surface 34D of the container peripheral wall is surrounded by the shoulder 34A, and surrounds the top container opening O_{T}. The inner peripheral surface 34D defines an inner container wall periphery 34D′ (hereinafter “inner wall periphery” 34D′ or “second container opening periphery” 34D′) that is spaced from the inner shoulder periphery 34A′ toward the interior of the container 30. The inner peripheral surface 34D may have a narrowing shape suitable for channeling waste toward the bottom 24 of the bag 22, in which case the inner wall periphery 34D′ is smaller than the inner shoulder periphery 34A′, and would hence be the throat of the device 10. The container 30 may thus be said to be configured for use with bags 22 whose bottom bag dimension 24′ is smaller than or equal to the inner wall periphery 34D′, or other throat of the device 10. By this arrangement, the mere filling of the bottom 24 of the bag 22, which may result in the bag 22 and its contents reaching a maximum circumference smaller than the bottom bag dimension 24′, would not prevent removal of the bag 22 and its contents from the container 30 via the top container opening O_{T}. An outer peripheral surface 34E of the peripheral wall surrounds the shoulder 34A. The container rim 34 is separable from the body 32, although it is contemplated that the body 32 and the container rim 34 may form an integral piece. In such implementations, the container rim 34 sits atop the body 32, and the inner and outer peripheral surfaces 34D, 34E respectively correspond to interior and exterior surfaces of the body 32.

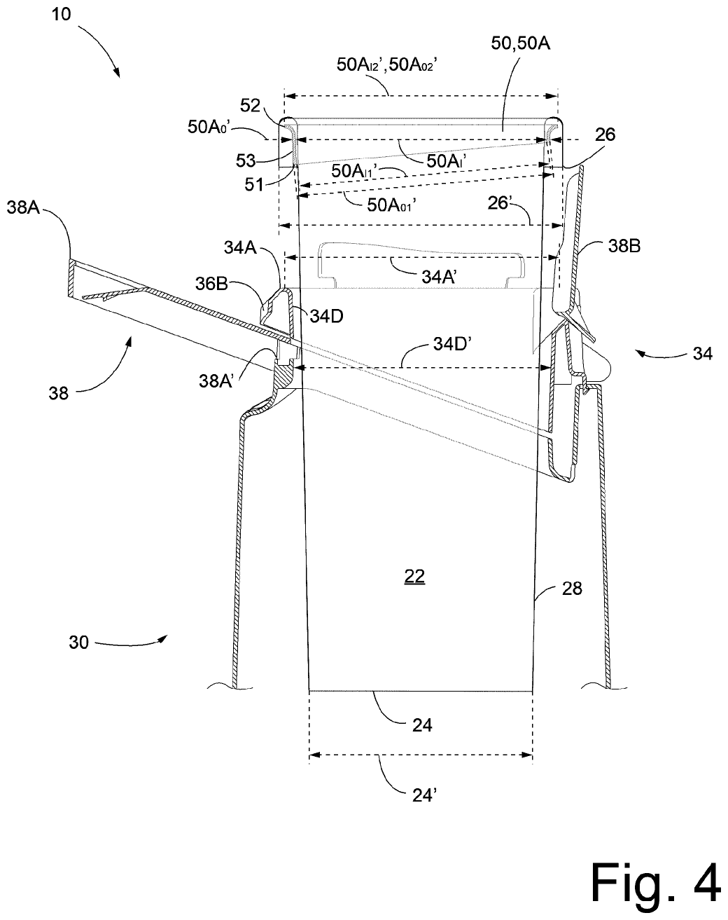

The container 30 may also include a bag closing mechanism 38. In the depicted exemplary implementation, the bag closing mechanism 38 includes a first door 38A and a second door 38B movably connected to the peripheral wall 36 and cooperable with one another so as to impinge on the bag 22 between the brim 26 and the bottom 24, when the bag 22 hangs from the shoulder 34A and into the interior of the container 30 via the top container opening O_{T}. The first door 38A may be a shutter-like member (hereinafter “shutter” 38A) received in a slot 38C extending through the peripheral wall from the outer peripheral surface 34E to the interior peripheral surface 34D. The shutter 38A is movable relative to the slot 38C between a deployed shutter position (FIGS. 1, 5 and 6) and a withdrawn shutter position (FIGS. 3, 4). In the deployed shutter position, the shutter 38A extends from the slot 38C and across the top container opening O_{T}. In the withdrawn shutter position, the shutter 38A extends from outside the container 30 and into the slot 38C, leaving the top container opening O_{T} largely unobstructed by the shutter 38A. The shutter 38A may be biased toward the deployed shutter position. The second door 38B may be a flap-like member (hereinafter “flap” 38B) pivotally connected relative to the peripheral wall, in this case in a recess 38D that extends downwardly into the shoulder 34A and traverses the peripheral wall from the interior peripheral surface 34D to the outer peripheral surface 34E. The flap 38B is movable relative to the recess 38D from a lowered flap position (FIGS. 1, 5 and 6) to a raised flap position (FIGS. 3, 4). In the lowered flap position, the flap 38B extends from the recess 38D and into the top container opening O_{T}. In the raised flap position, the flap 38B extends generally vertically so as to remain clear of the top container opening O_{T}. When the shutter 38A is in the deployed shutter position and the flap 38B is in the lowered flap position, the flap 38B overlaps the shutter 38A and rests on the shutter 38A. It is contemplated that the shutter 38A and the flap 38B could otherwise be arranged such that the shutter 38A overlaps the flap 38B instead. This is a non-limitative example of a bag closing mechanism 38, with numerous other options being possible, such as in described in U.S. patent application Ser. No. 17/277,361, incorporated herein by reference. Other bag closing mechanisms could be used as well. The bag closing mechanism 38 could be the throat of the device 10.

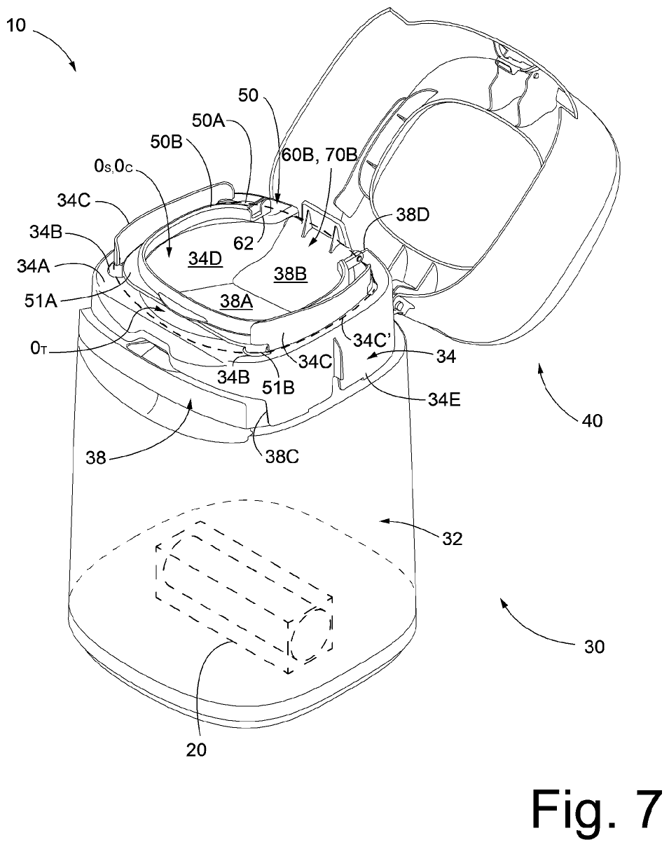

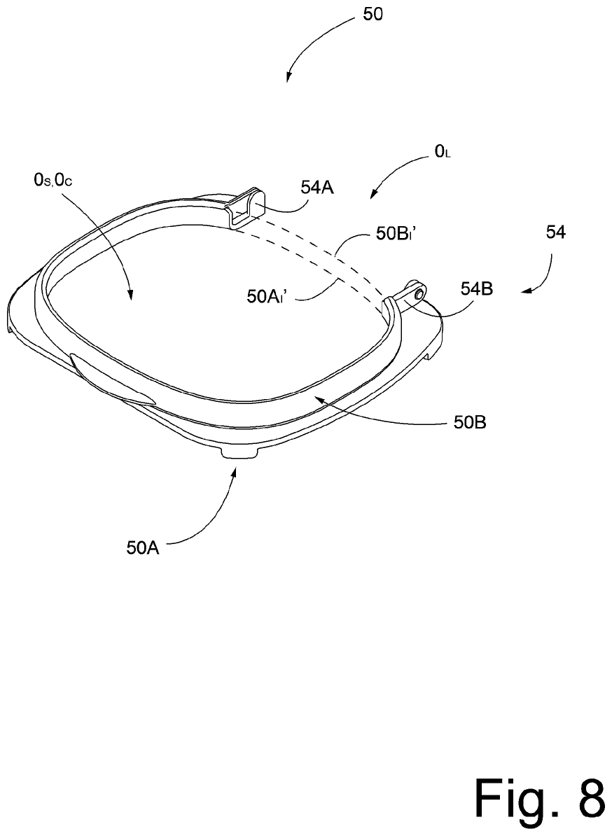

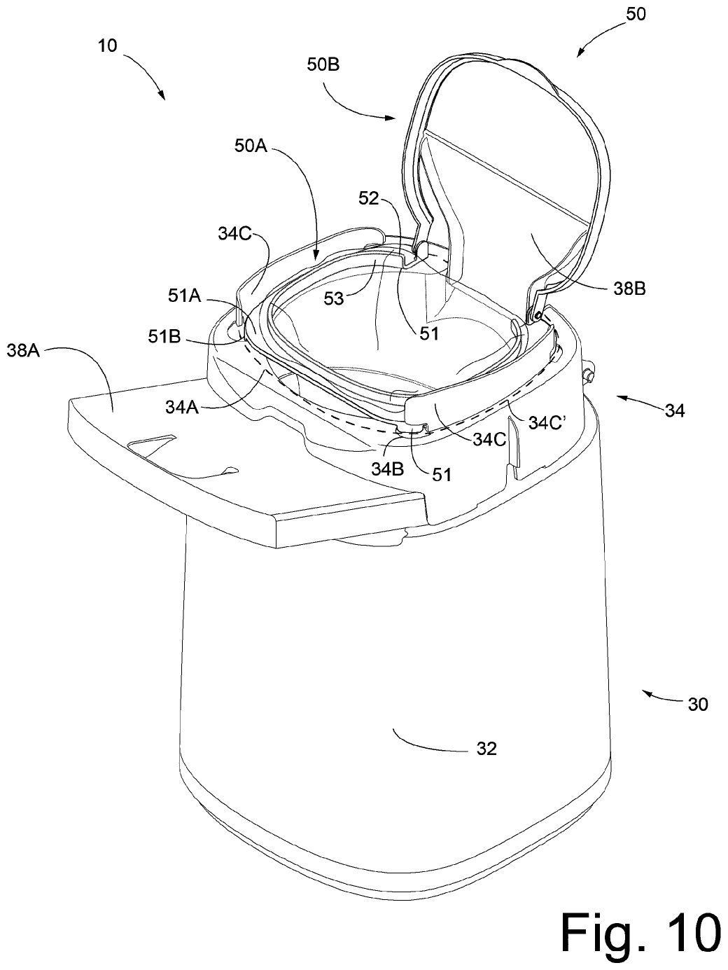

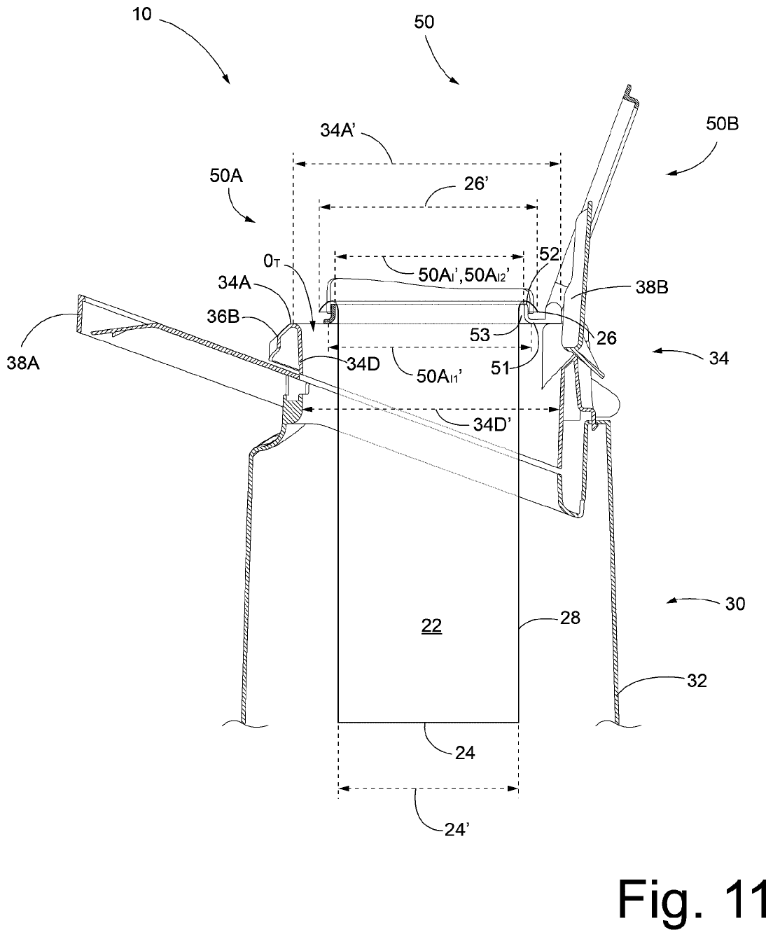

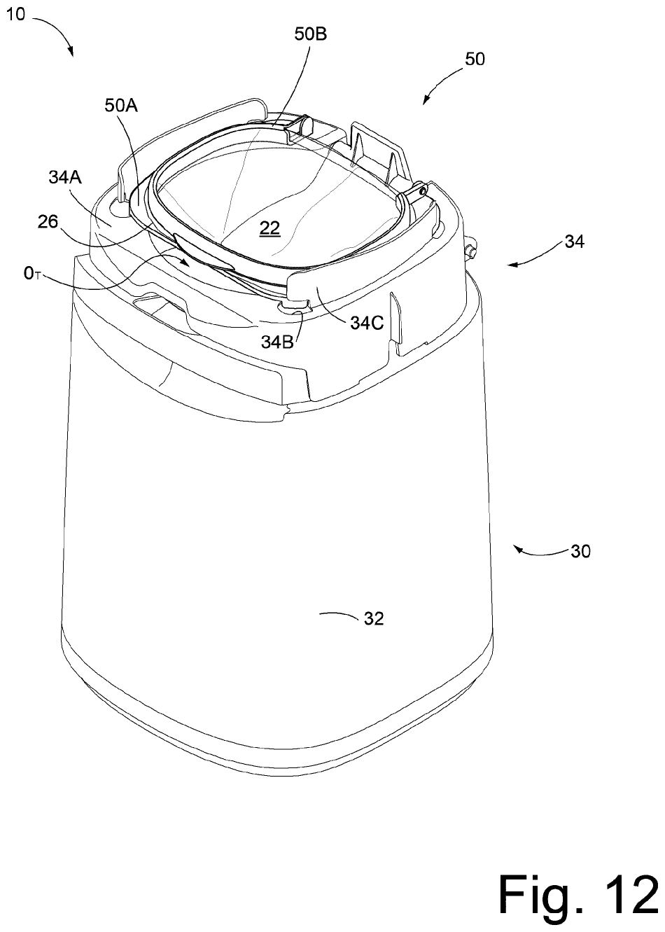

The bag adapter 50 will now be generally described. The bag adapter 50 generally includes at least one frame-like structure 50A (FIGS. 1-13), 50B (FIGS. 7-13). For example, in the exemplary embodiment depicted in FIGS. 1-6, the bag adapter 50 includes a sole frame-like structure referred to hereinafter as “seating frame” 50A, whereas in some others, such as the embodiment depicted in FIGS. 7-13, the bag adapter 50 includes a first frame-like structure being another seating frame 50A and a second frame-like structure referred to hereinafter as “clamping frame” 50B. The seating frame 50A in FIGS. 1-6 has an annular body.

The seating frame 50A has an inner profile extending peripherally so as to define a seating frame opening O_{S}, and heightwise between a bottom seating frame edge 51 and a top seating frame edge 52. The seating frame 50A is sized to be seated onto the container rim 34 proximate to the inner shoulder periphery 34A′, such that the seating frame opening O_{S} is in communication with the top container opening O_{T}, with the bottom seating frame edge 51 facing toward the container 30 and the top seating frame edge 52 facing away therefrom.

Referring to FIG. 4, the inner profile of the seating frame 50A has an inner seating frame periphery 50A\′ (that could be said to be a circumference) circumscribing the seating frame opening O_{S}. Depending on the embodiment, the inner profile of the seating frame 50A may have a plurality of circumferences or peripheries of different sizes circumscribing the seating frame opening O_{S}, in which case the inner seating frame periphery 50A_{I}′ is the smallest one. The inner seating frame periphery 50A_{I}′ is at least equal to the bottom bag dimension 24′, or may be greater. For clarity, the bag 22 may be a different bag than those configured to be used with the device 10, such a bag 22 being configured to be used specifically with the bag adapter 50. By this arrangement, the mere filling of the bag bottom 24, which may result in the bag 22 and its contents reaching a size smaller than the bottom bag width 24′, would not prevent removal of the bag 22 and its contents from the container 30 via the top container opening O_{T} and the seating frame opening O_{S}. At the bottom seating frame edge 51, the inner profile has a bottom inner seating frame periphery 50A_{I1}′ and at the top seating frame edge 52, the inner profile has a top inner seating frame periphery 50A_{I2}′. A largest one of the peripheries circumscribing the seating frame opening O_{S} may for example be the top inner seating frame periphery 50A_{I2}′.

Still referring to FIG. 4, the seating frame 50A has an outer profile located peripherally relative to the inner profile and facing outwardly relative to the seating frame opening O_{S}. The outer profile has an outer seating frame periphery 50A_{O}′ that is greater than the inner seating frame periphery 50A_{I}′. The outer seating frame periphery 50A_{O}′ is shaped so as to overhang the container rim 34 peripherally to the top container opening O_{T} at locations suitable for the seating frame 50A to rest atop the container rim 34 with the seating frame opening O_{S} being in register with the top container opening O_{T}. The outer profile may have a plurality of peripheries of different sizes that are shaped as such. At the bottom seating edge 51, the outer profile has a bottom outer seating frame periphery 50A_{O1}′ and at the top seating frame edge 52, the outer profile has a top outer seating frame periphery 50A_{O2}′. The top outer seating frame periphery 50A_{O2}′ may be smaller than the top bag periphery 26′ such that the bag brim 26 may be fitted around the top seating frame edge 52 in an unstretched condition, i.e., absent any elastic or plastic deformation of the bag 22 relative to its initial, as manufactured condition. The bag 22 may also be stretched to be fitted around the tip seating frame edge 52.

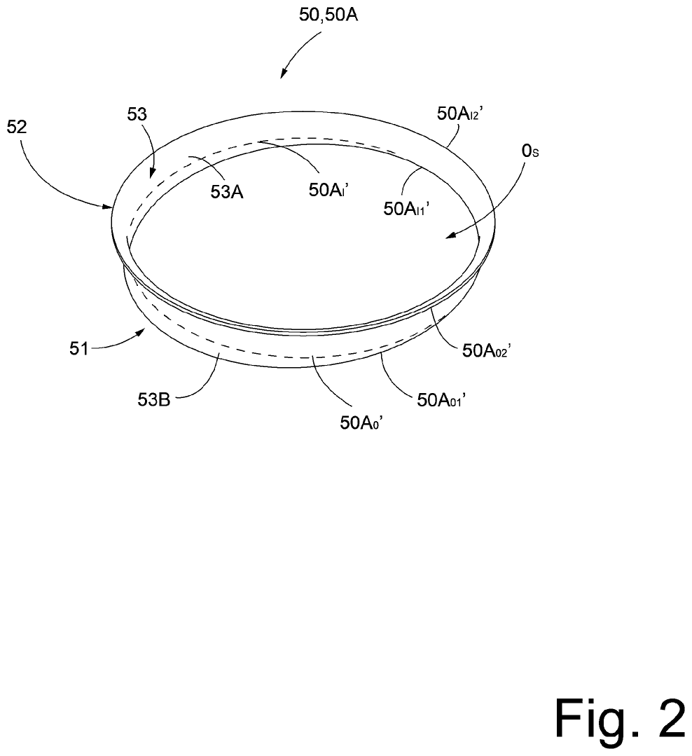

Various shapes may be suitable for the seating frame 50A. In the embodiment of FIGS. 1-6, the seating frame 50A has a wall-like cross-section that varies in size as it surrounds the seating frame opening O_{S}. The seating frame 50A defines a peripheral seating frame wall extending from the bottom seating frame edge 51 to the top seating frame edge 52. As best seen in FIG. 2, the peripheral seating frame wall 53 has an inner surface 53A surrounding the seating frame opening O_{S} and an outer surface 53B surrounding the inner surface 53A. The inner surface 53A and the outer surface 53B in this case respectively correspond to the inner profile and to the outer profile.

The inner seating frame periphery 50A_{I}′, i.e., the smallest circumference of the inner profile delimiting the seating frame opening O_{S}, is in this case defined by the inner surface 53A proximate to the bottom seating frame edge 51. As shown, the inner surface 53A may funnel between the top inner seating frame periphery 50A_{I2}′ and the inner seating frame periphery 50A_{I}′. The inner surface 53A may also extend past the inner seating frame periphery 50A_{I}′ as it extends from the top inner seating frame periphery 50A_{I2}′ to the bottom inner seating frame periphery 50A_{I1}′. Indeed, the bottom seating frame edge 51 may be offset, slanted and/or curved relative to the inner seating frame periphery 50A_{I}′, and thus the bottom inner seating frame periphery 50A_{I1}′ at the junction between the bottom seating frame edge 51 and the inner surface 53A may circumscribe the seating frame opening O_{S} without following the inner seating frame periphery 50A_{I}′ in its entirety.

The outer seating frame periphery 50A_{O}′ is in this case depicted as following the inner seating frame periphery 50A_{I}′ from across the peripheral seating frame wall 53. However, it should be noted that in this embodiment, the outer surface 53B conforms to a portion of the container rim 34 having a constricting shape and extending from the shoulder circumference 34A′ toward the inner wall circumference 34D′. This is optional, for instance by having the bag adapter 50 sitting directly on the shoulder 34A. As such, both the outer seating frame periphery 50A_{O1}′ and the top outer seating frame periphery 50A_{O2}′ may be said to be shaped so as to overhang the container rim 34 peripherally to the top container opening O_{T} at locations suitable for the seating frame 50A to rest atop the container rim 34. In another alternative, the bag adapter 50 overhangs by the presence of fingers or tongues projecting outwardly (e.g., radially) from the outer surface 53B for example. Such fingers or tongues may be used as retainers for a bag 22 attached to the bag adapter 50.

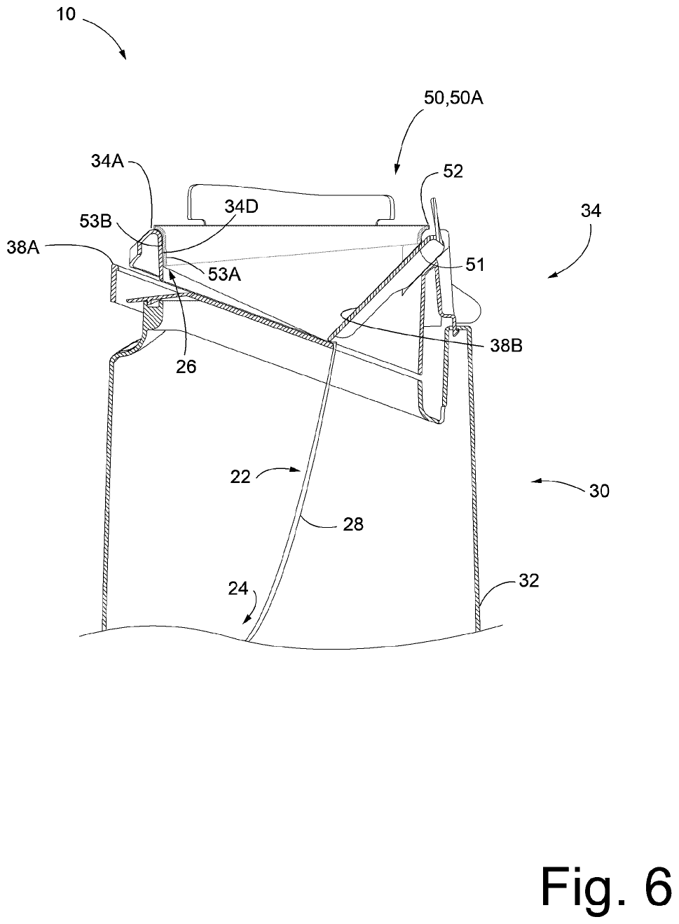

As best seen in FIG. 6, the seating frame 50A is shaped such that it may be seated onto the container rim 34 without interfering with the bag closing mechanism 38 at least under certain circumstances. For instance, the seating frame 50A is seatable when the flap 38B is in the lowered flap position regardless of whether the shutter 38A is in the withdrawn or deployed shutter position. With the seating frame 50A seated, movement of the flap 38B from the lowered flap position toward the raised flap position may be hindered by the seating frame 50A, whereas movement of the shutter 38A to and fro the withdrawn shutter position and the deployed shutter position may be unhindered by the seating frame 50A.

In use, the bag 22 is installed onto the seating frame 50A by cuffing the bag brim 26 around the top seating frame edge 52, with the peripheral bag wall 28 extending through the seating frame opening O_{S} such that the bag bottom 24 hangs below the bottom seating frame edge 51. If fingers or tongues are present, the bag brim 26 may be hooked onto them before the cuffing. Then, the seating frame 50A is seated onto the container rim 34 with the bag 22 so installed onto the seating frame 50A, such that any portion of the bag 22 depending from the seating frame 50A is received by the interior of the container 30. As the seating frame 50A is being seated onto the container rim 34, the bag brim 26 may advantageously be squeezed between the seating frame 50A and the container rim 34, for example where the outer seating frame circumference 50A_{O}′ overhangs the container rim 34, thereby increasing a hold of the seating frame 50A onto the bag 22. Again, this is optional as the bag adapter 50 may simply lie on the shoulder surface 34A.

Referring to FIGS. 7 to 13, another exemplary embodiment of the bag adapter 50 is shown, wherein like elements bear like numerals. As mentioned hereinabove, the bag adapter 50 may include the seating frame 50A and another frame-like structure such as the clamping frame 50B. The clamping frame 50B may be generally described as a means for increasing the hold of the seating frame 50A onto the bag 22 while leaving the seating frame opening O_{S} largely unobstructed by such means. The clamping frame 50B extends peripherally so as to define a clamping frame opening O_{C}, and has an inner clamping frame periphery 50B_{I}′ (e.g., a circumference) circumscribing the clamping frame opening O_{C}. Depending on the embodiment, the clamping frame 50B may have a plurality of peripheries of different sizes circumscribing the clamping frame opening O_{C}, in which case the inner clamping frame periphery 50B_{I}′ is the smallest one. The inner clamping frame periphery 50B_{I}′ may be at least equal to the bottom bag periphery 24′. For clarity, the bag 22 may be a different bag than is configured to be used with the device 10, such a bag 22 being configured to be used specifically with the bag adapter 50. By this arrangement, the mere filling of the bag bottom 24, which may result in the bag 22 and its contents reaching a periphery smaller than the bottom bag periphery 24′, would not prevent or hamper removal of the bag 22 and its contents from the container 30 via the top container opening O_{T} and the clamping frame opening O_{C}. The clamping frame 50B forms a clamping frame profile that is complementary to a corresponding seating frame profile formed by one or more of the top seating frame edge 52, the inner profile and the outer profile of the seating frame 50A. The clamping frame 50B may thus be fitted onto the seating frame 50A such that the clamping frame profile closely follows the seating frame profile whereas the clamping frame opening O_{C} is in communication with the seating frame opening O_{S}. Various cross-sectional shapes are contemplated for the clamping frame profile, including but not limited to “I”, “L” and “U”-like shapes. The clamping and seating frame profiles may also be arranged so as to provide some mechanical retention of the clamping frame 50B with respect to the seating frame 50A, with either one or both of the clamping and seating frame profiles being resiliently deformable so as to receive the other as the clamping frame 50B is being fitted onto the seating frame 50A. Upon fitting the clamping frame 50B onto the seating frame 50A with the bag brim 26 being disposed along the seating frame shape, the bag brim 26 becomes clamped between the seating frame 50A and the clamping frame 50B, thereby increasing the hold of the seating frame 50A onto the bag 22.

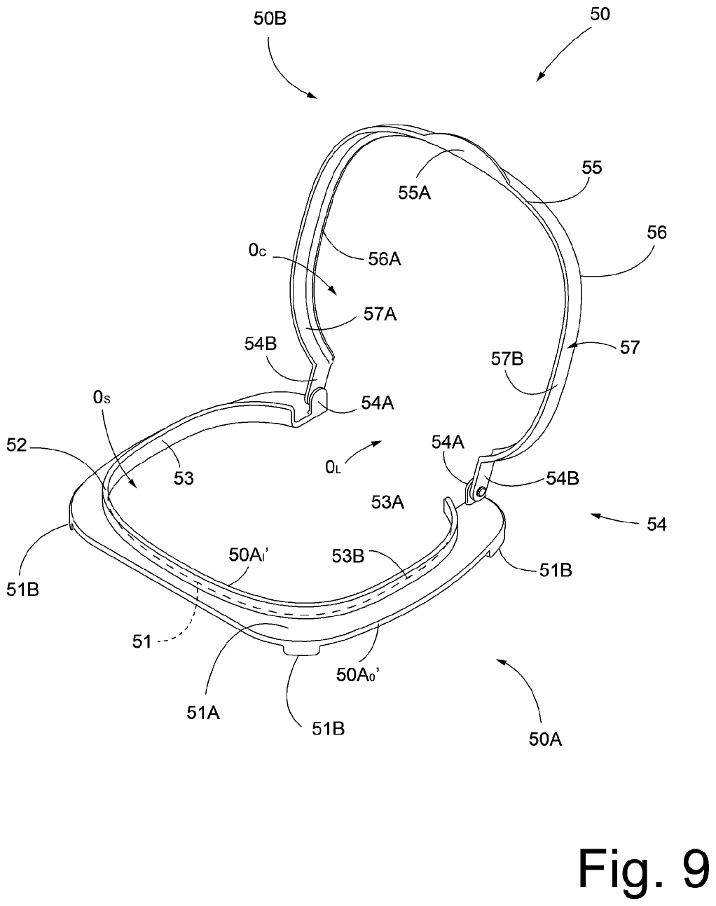

In some embodiments, the bag adapter 50 is provided with a hinge 54 via which the seating frame 50A and the clamping frame 50B are connected to one another. At the hinge 54, the clamping frame 50B is pivotable relative to the seating frame between an open clamp position and a closed clamp position. In the open clamp position (FIGS. 9-11), the clamping frame 50B is at an angle relative to the seating frame 50A, and the clamping frame profile is spaced relative to the seating frame profile such that the seating frame profile is free to be overlaid with the bag brim 26. In the closed clamp position (FIGS. 7-8 and 12-13), the clamping frame 50B overlays the seating frame 50A, and the clamping frame profile follows the seating frame profile. In some embodiments, as shown, seating frame 50A is laterally open such that at least the seating frame opening O_{S} is not fully enclosed by the seating frame 50A—this is optional. The bag adapter 50 may for example define a lateral opening O_{L} sized to allow the flap 38B to be moved between the raised and lowered flap positions unhindered by the bag adapter 50 provided that the lateral opening O_{L} is suitably aligned with the flap 38B when the seating frame 50A is seated on the container rim 34. In the depicted embodiment, both the seating frame 50A and the clamping frame 50B are open laterally, and the lateral opening O_{L} is defined at the hinge 54. On either side of the lateral opening O_{L}, a first portion 54A of the hinge defined by the seating frame 50A is pivotally connected to a complementary second portion 54B of the hinge 54 defined by the clamping frame 50B.

Referring to FIG. 9, the peripheral seating frame wall 53 of the annular body extends straight from the top seating frame edge 52 and flares as it nears the bottom seating frame edge 51. Hence, in this embodiment, the inner seating frame periphery 50A′ corresponds to the top inner seating frame periphery 50A_{I2}′, and the bottom inner seating frame periphery 50A_{I1}′ is greater than the top inner seating frame periphery 50A_{I2}′.

The seating frame 50A may include a flange 51A extending outwardly relative to the peripheral seating frame wall 53, i.e., projecting from the outer surface 53B. In this embodiment, the flange 51A defines the outer seating frame periphery 50A_{O}′. The flange 51A is sized so as to overhang the shoulder 34A, for example inwardly of the collars 34C. It should also be noted that the outer seating frame periphery 50A_{O}′ is in this case smaller than the bag deployment periphery 34C′. The seating frame 50A may also include tabs 51B disposed on the bottom seating frame edge 51 and extending away from the top seating frame edge 52. The tabs 51B may be sized and arranged so as to extend into at least some of the holes 34B defined in the container rim 34, which may aid in holding the seating frame 50A in place relative to the container 30. In the depicted exemplary arrangement, the tabs 51B are located proximate to the outer seating frame periphery 50A_{O}′ and project from the flange 51A.

The clamping frame 50B may include a bottom clamping frame edge 55, a top clamping frame edge 56 and a peripheral clamping frame wall 57 extending from the bottom clamping frame edge 55 to the top clamping frame edge 56. The peripheral clamping frame wall 57 has an inner surface 57A surrounding the clamping frame opening O_{C} and an outer surface 57B surrounding the inner surface 57A.

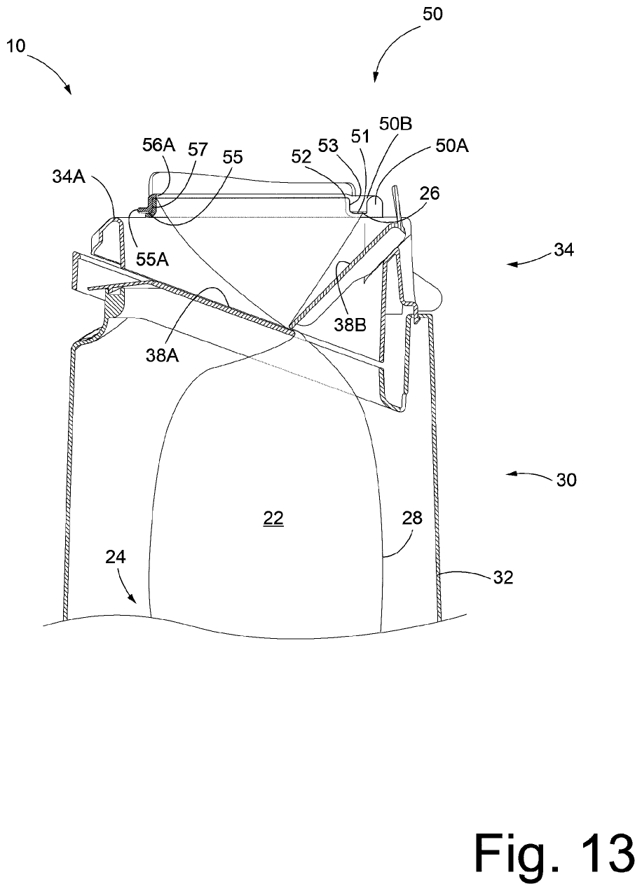

The bottom clamping frame edge 55 may include a tab 55A extending outwardly relative to the peripheral clamping frame wall 57, i.e., projecting from the outer surface 57B. The top clamping frame edge 56 may include a lip 56A extending inwardly relative to the peripheral clamping frame wall 57, i.e., projecting from the inner surface 57A. In this embodiment, as best seen in FIG. 13, the lip 56A is sized so as to rest onto the top seating frame edge 52 when the clamping frame 50B is fitted to the seating frame 50A. The lip 56A and the peripheral clamping frame wall 57 together form the clamping frame profile, whereas the peripheral seating frame wall 53 and the top seating frame edge 52 together form the seating frame profile.

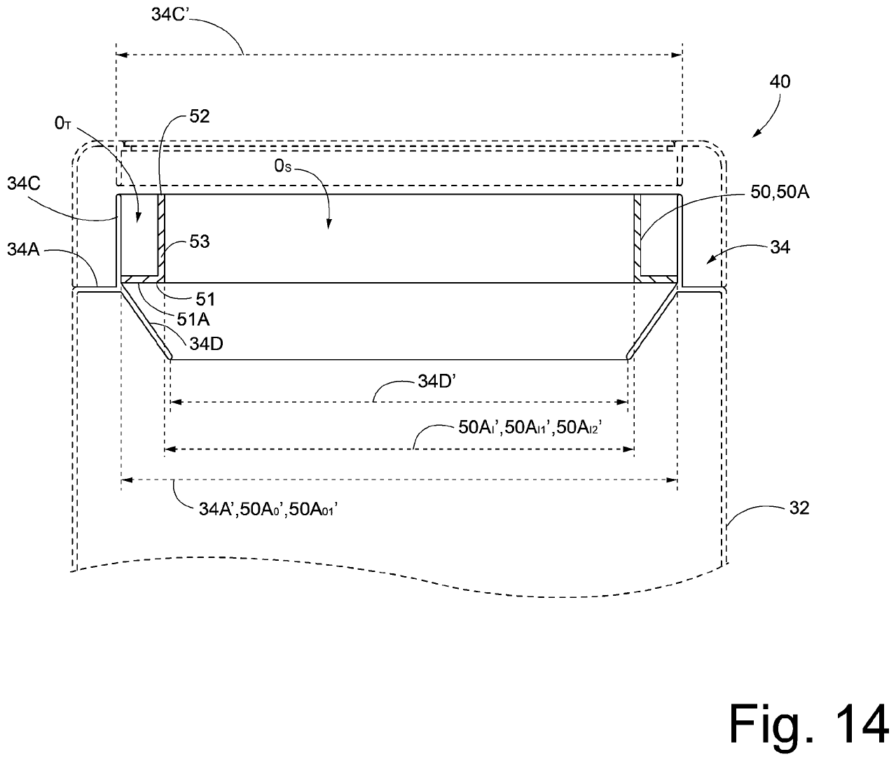

In FIG. 14, another exemplary embodiment of the bag adapter 50 is shown together with a different implementation of the waste disposal device 10, wherein like elements bear like numerals. The container 30 of the device 10 has a sole collar 34C, also referred to as a tubular bag support, extending peripherally around the top container opening O_{T} on top of the shoulder 34A. In this embodiment, the collar 34C and the inner peripheral surface 34D meet proximate to the shoulder periphery 34A′. The bag deployment periphery 34C′, or outer periphery of the collar 34C, may for example be slightly larger than the shoulder periphery 34A′, whereas an inner periphery of the collar 34C may correspond to the shoulder periphery 34A′. The inner peripheral surface 34D may be circumscribed by the shoulder periphery 34A′ and taper from the shoulder periphery 34A′ to the inner wall periphery 34D′.

In this embodiment, the seating frame 50A is the sole frame-like structure of the bag adapter 50 provided with an “L”-shaped cross-section. The seating frame 50A extends from the bottom seating frame edge 51 to the top seating frame edge 52, defining a height in this case corresponding to that of the collar 34C. On the inside of the seating frame 50A, the peripheral seating frame wall 53 is straight, such that the bottom inner seating frame periphery 50A_{I1}′, the top inner seating frame periphery 50A_{I2}′ and the inner seating frame periphery 50A_{I}′ may be said to match. On the outside of the seating frame 50A, the flange 51A provided at the bottom seating frame edge 51 is circumscribed by the bottom outer seating frame periphery 50A_{O1}′, which in this case corresponds to the outer seating frame periphery 50A_{O}′. The outer seating frame periphery 50A_{O}′ is greater than the inner wall circumference 34D′ yet greater than the shoulder circumference 34A′. As such, the seating frame 50A may be seated onto the container rim 34 inward of the collar 34C.

Therefore, the bag adapters 50 described herein, for any of the variants of FIG. 1-6, 7-13 or 14, are used to enable the use of generic bags with the device 10 or variants of the device 10. The bags 22 configured to be used with the device 10, such as bags deployed from the cassette 20 in the bottom of the device 10, may have specific dimensions requirements, for the filled bag bottom 24 to be removed through the container opening O_{T} by upward movement, all the while being sufficiently large to be hung by the bag retention features 34B, 34C. The bag adapters 50 may be provided for other bags 22, that do not have the specific sizing features, to be used with the device 10. The bag adapters 50 have to be sized to be mounted to the device 10 in any appropriate way, as described above, and the bags must be sized at or near their brims to be retained to the bag adapters 50. The bags must however be small enough at their bottoms 24 to be removed through the container opening O_{T} by upward movement, and through the seating frame opening O_{S}, or through any throat of the device 10, including the bag closing mechanism 38 if present. To achieve this the bottom bag periphery of such a bag is at most equal to the bottom bag periphery of the bag 22 configured to be mounted to the bag retention features 34B, 34C.

The bag adapter can generally be described as having a bottom bag circumference associated with a first bag to a top container rim of a container having an inner container wall circumference at least equal to the bottom bag circumference and an inner container shoulder circumference greater than the inner container wall circumference, spaced from one another and circumscribing a container opening. The bag adapter may have a seating frame having an inner seating frame circumference at least equal to a bottom bag circumference associated to a second bag, wherein the bottom bag circumference of the second bag is at most equal to the bottom bag circumference of the first bag, the inner seating frame circumference circumscribing a seating frame opening, the seating frame sized to be seated mounted onto the top container rim proximate to the inner container shoulder circumference such that the seating frame opening is in communication with the container opening.

The bag adapter can also be generally described as being for hanging a bag to a top container rim of a container circumscribing a container opening at least equal in dimension to the bottom bag dimension, a bag having a bottom bag dimension at most equal to a throat section of the container, the container opening being at least equal in dimension to the bottom bag dimension, the bag adapter comprising a seating frame having an inner seating frame periphery circumscribing a seating frame opening, the seating frame sized to be mounted onto the top container rim such that the seating frame opening is in communication with the container opening. The seating frame may have an annular body. The annular body may taper from a top peripheral edge to a bottom peripheral edge. The annular body may define an outer seating frame periphery that corresponds in shape and/or in dimension to seating frame opening. The outer seating frame periphery may be between the top peripheral edge and the bottom peripheral edge such that the annular body is seated in the seating frame opening. The annular body may have a bottom peripheral edge having a dimension greater than that of the container opening, such that the annular body is configured to be seated to a surface of the container surrounding the container opening. A flange may project from and surrounds the annular body, the flange configured to be supported against a surface of the container when the bag adapter is mounted to the container. The seating frame may be laterally open. A clamping frame may be pivotally connected to the seating frame, the clamping frame closing onto the seating frame to hold a bag therebetween. The seating frame may have a bottom peripheral edge having a dimension greater than that of the container opening, such that the seating frame is configured to be seated to a surface of the container surrounding the container opening.

A flange may project from and surrounds the seating frame, the flange configured to be supported against a surface of the container when the bag adapter is mounted to the container. The seating frame may have at least one tab projecting from the flange, the at least one tab projecting toward the container upon the bag adapter being mounted to the container. A tab projects from the clamping frame, the tab for pivoting the clamping frame relative to the seating frame. A kit may include the bag adapter as described above in any of the embodiment, and at least one bag, the bag having a bottom bag dimension at most equal to a throat section of the container. The bottom bag dimension may have a dimension smaller than the seating frame opening. The bottom bag dimension may be smaller than a top bag periphery. The kit may include a plurality of the bag, such as in a roll, and optionally with the bags in the roll are connected from a bottom of one of the bags to a top of a subsequent one of the bags. The roll may optionally be in a cassette body.

1. A bag adapter for hanging a bag to a top container rim of a container circumscribing a container opening at least equal in dimension to the bottom bag dimension, a bag having a bottom bag dimension at most equal to a throat section of the container, the container opening being at least equal in dimension to the bottom bag dimension, the bag adapter comprising a seating frame having an inner seating frame periphery circumscribing a seating frame opening, the seating frame sized to be mounted onto the top container rim such that the seating frame opening is in communication with the container opening.

2. The bag adapter according to claim 1, wherein the seating frame has an annular body.

3. The bag adapter according to claim 2, wherein the annular body tapers from a top peripheral edge to a bottom peripheral edge.

4. The bag adapter according to claim 3, wherein the annular body defines an outer seating frame periphery that corresponds in shape and/or in dimension to seating frame opening.

5. The bag adapter according to claim 4, wherein the outer seating frame periphery is between the top peripheral edge and the bottom peripheral edge such that the annular body is seated in the seating frame opening.

6. The bag adapter according to claim 2, wherein the annular body has a bottom peripheral edge having a dimension greater than that of the container opening, such that the annular body is configured to be seated to a surface of the container surrounding the container opening.

7. The bag adapter according to claim 2, wherein a flange projects from and surrounds the annular body, the flange configured to be supported against a surface of the container when the bag adapter is mounted to the container.

8. The bag adapter according to claim 1, wherein the seating frame is laterally open.

9. The bag adapter according to claim 8, further comprising a clamping frame pivotally connected to the seating frame, the clamping frame closing onto the seating frame to hold a bag therebetween.

10. The bag adapter according to claim 9, wherein the seating frame has a bottom peripheral edge having a dimension greater than that of the container opening, such that the seating frame is configured to be seated to a surface of the container surrounding the container opening.

11. The bag adapter according to claim 9, wherein a flange projects from and surrounds the seating frame, the flange configured to be supported against a surface of the container when the bag adapter is mounted to the container.

12. The bag adapter according to claim 11, wherein the seating frame has at least one tab projecting from the flange, the at least one tab projecting toward the container upon the bag adapter being mounted to the container.

13. The bag adapter according to claim 9, wherein a tab projects from the clamping frame, the tab for pivoting the clamping frame relative to the seating frame.

14. A kit comprising:
the bag adapter according to claim 1; and
at least one bag, the bag having a bottom bag dimension at most equal to a throat section of the container.

15. The kit according to claim 14, wherein the bottom bag dimension has a dimension smaller than the seating frame opening.

16. The kit according to claim 14, wherein the bottom bag dimension is smaller than a top bag periphery.

17. The kit according to claim 14, comprising a plurality of the bag.

18. The kit according to claim 15, wherein the bags of the plurality are in a roll.

19. The kit according to claim 18, wherein the bags in the roll are connected from a bottom of one of the bags to a top of a subsequent one of the bags.

20. The kit according to claim 18, wherein the roll is in a cassette body.
